(19) United States
(12) Patent Application Publication
(10) Pub. No.: US 2016/0144490 A1
(43) Pub. Date: May 26, 2016

(54) EXTENSION WRENCH SET HAVING WRENCHES SLIDEABLE IN REVERSE AND FORWARD DIRECTIONS

(71) Applicant: Thomas Carnesi, Torrance, CA (US)

(72) Inventor: Thomas Carnesi, Torrance, CA (US)

(21) Appl. No.: 14/552,935

(22) Filed: Nov. 25, 2014

(51) Int. Cl. B25B 13/56; B25G 1/08; B25B 13/08

(52) U.S. Cl. CPC B25B 13/56; B25B 13/08; B25G 1/085

(57) ABSTRACT

A wrench set comprising a plurality of different sized wrenches each of which are slideable within an elongated housing. A user selects a particular wrench by choosing an associated knurled protrusion and forcing the wrench in the forward or reverse direction by moving the knurled protrusion in that direction.

### BACKGROUND OF THE INVENTION

1. Field of the Invention

The present invention provides a slideable forward and reversible open end wrench set that is stackably tiered and retractable when not in use.

2. Description of the Prior Art

The concept of having a single wrench tool having the capability of operating on nuts of various diameters has been disclosed in the prior art. For example, U.S. Pat. No. 8,387,489 to Hsu is typical of such devices and discloses a multi-size ratchet wrench which includes a handle having two ends, at least one of which forms a head that receives and retains therein a fitting assembly that effect single direction driving. The fitting assembly rotatably supports a rotatable block that has a rotational axis substantially perpendicular to a rotational axis of the fitting assembly. The rotatable block has a circumferential surface forming one or multiple fitting sections that are substantially normal to the rotational axis of the rotatable block allowing a user to select among differently-sized fitting sections through direct rotation of the rotatable block.

Although the Hsu patent describes a wrench which reduces the number of sockets that one needs to carry when a repair or installation is required, the mechanism required is expensive to fabricate and depends upon the life and reliability of the rotatable block.

What is desired is to provide a wrench that avoids the disadvantages of prior art, multiple socket wrenches of the type disclosed by Hsu.

### SUMMARY OF THE INVENTION

The present invention provides a compact, slidable and stackable open flat end wrench set having a first tier wrench with a ¾ inch socket on one end, the opposite end having a 11/16 socket; a second tier wrench with a ⅝ socket at one end and a 9/16 socket at the opposite end; a third tier wrench having a inch socket one at end and a 7/16 inch socket at the opposite end; and a fourth tier wrench having a ⅜ inch socket at one end and a 5/16 socket at the opposite end. The four tiered wrenchs are housed within a partially cylindrical housing that is knurled for gripping the stackable tiered wrench. The tiered wrenches are retained within the cylindrical housing by a central guide pin that rides within a longitudinal slot. This design provides for convenience of use, compactness when stored, ease of use with a substantial torque strength.

The wrench set can slide forward, is reversible and is retractable. Each individual wrench has a knurled extended thumb feature for the user to slide the desired size in either forward or reverse longitudinal directions and preferably, protrudes from the right side of each slideable tiered wrench. Each of the four tiered wrenches have a longitudinal slot and are retained within the housing by a guide pin having a constant tension applied from a horizontal compression type spring. The spring is housed within the guide pin at a right angle. The guide slot located within each tiered wrench also includes a crosswise slot to retain the slideable wrenches at the guide pin location when the user either extends the selected wrench in either the forward or reverse directions. A central crosswise slot is also provided on each wrench to lock the wrench set at a central position when not in use.

### DESCRIPTION OF THE DRAWINGS

For a better understanding of the present invention as well as other objects and further features thereof, reference is made to the following description which is to be read in conjunction with the accompanying drawings wherein:

FIG. 1 is a perspective view of the wrench set of the present invention;

FIG. 2 is an exploded assembly view of the wrench set shown in FIG. 1;

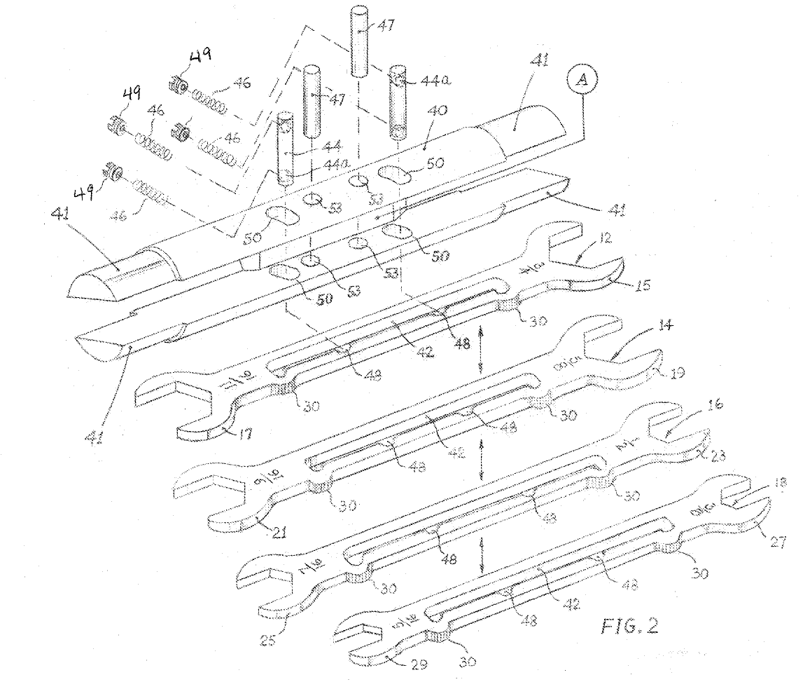

FIGS. 3(a)-3(c) show positions of a selected wrench in accordance with the teachings of the present invention; and

FIGS. 4(a)-4(e) show various external and sectional views of the wrench set of the present invention.

### DESCRIPTION OF THE INVENTION

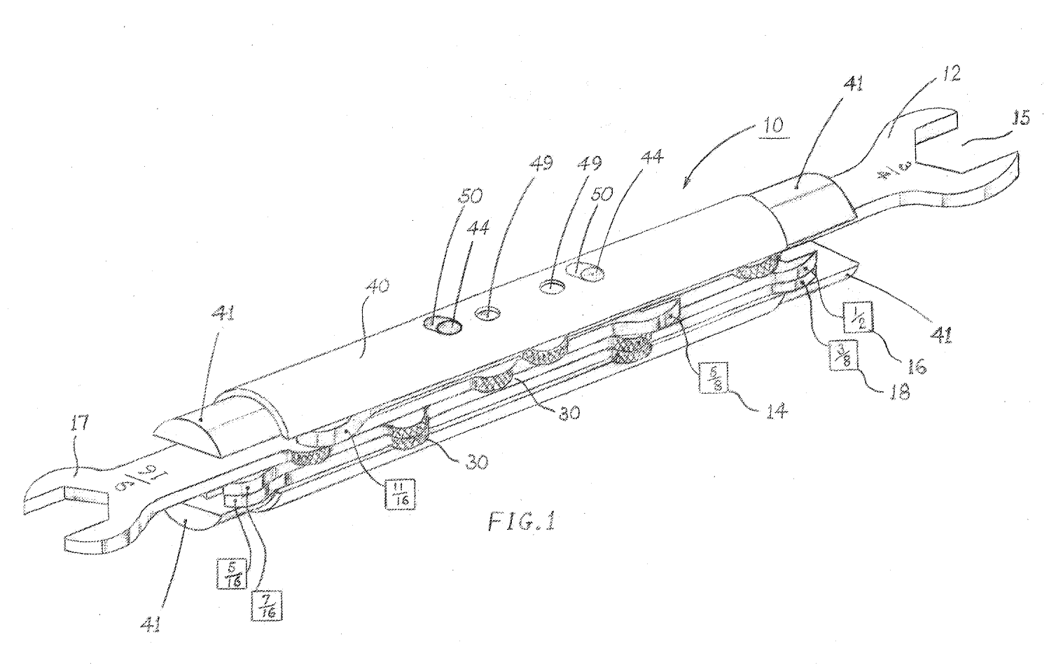

FIG. 1 is a perspective view of the wrench set 10 of the present invention. Wrench set 10 comprises four tiered flat wrenches 12, 14, 16 and 18 that are manually slideable in a longitudinal direction. Each individual wrench has two open-end sizes; the largest first tier slideable wrench 12 has a ¾ inch socket 15, the opposite end 17 having a socket 19 9/16 inch in size; the second tier wrench 14 has a ⅝ inch socket 21 on the front end and on the opposite (back) end, a 9/16 inch socket 23 in size; the third tier wrench 16 has a socket end 25 ½ inch in size at the front end, the opposite end having a 7/16 sized socket 29 and the fourth tier wrench 18 has the smallest size wrench, a ⅜ inch socket 27 on the front end and a 5/16 inch socket 31 at the opposite end (it is to be noted that other wrench sizes can be formed as part of the wrench set).

Each individual wrench has two knurled extended thumb portion 30 for the user to slide the desired size wrench in either a forward or reverse longitudinal direction. The knurled thumb piece 30 protrudes from the right side of each of the slideable tiered wrenches 12, 14, 16 and 18 and are in tandem (offset) locations for ease of selection. The tiered wrenches 12, 14, 16 and 18 are housed inside a cylindrical housing 40 for ease of storage and compactness and includes a smaller step-down portion 41. The wrench housing 40 has a knurled exterior and is slotted to retain the four tiered flat open-end wrenches 12, 14, 16 and 18. The four tiered wrenches 12, 14, 16 and 18 each have longitudinal slots 42 and are retained by tension induced guide pins 44 which are positioned within wrench housing 40 and ride within the longitudinal slots 42 of the wrench selected for use. Constant tension is applied by compression type springs 46, the springs being housed within the guide pins 44 at right angles. Slotted capscrews 49 are provided at each end of guide pins 44 to retain them in position within housing 40. The guide slot 42 located within each tiered wrench have crosswise slots 48 to retain the selected slideable wrench at the guide pins 42 when the user either extends the desired wrench in a forward or reverse size setting and thus locking the wrench at the selected forward or reverse positions. Central crosswise slots 50 lock the tiered wrenches centrally when the wrench set 10 is not in use.

A pair of stabilizer pins 47 are positioned in holes 53 formed in housing 40, are provided so that the four stacked wrenches 12, 14, 16 and 18 remain along the longitudinal axis of wrench set 10. Without the stabilizer pins, the stacked wrenches will shift laterally outwards for approximately ⅛ inch.

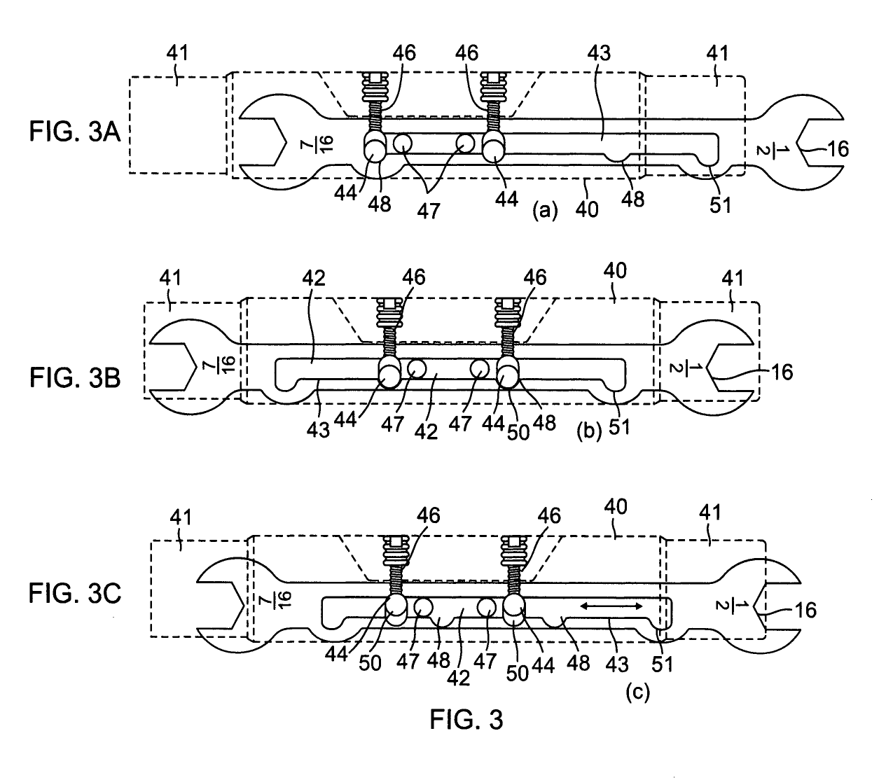

FIG. 3(a) is an end view of the wrench set 10 along line A-A shown in FIG. 3(d). FIG. 3(b) is a view along line B-B of FIG. 3(d); FIG. 3(c) is a view along line C-C of FIG. 3(a); FIG. 3(d) is a view of wrench set 10 along line E-E of FIG. 3(a); and FIG. 3(e) is a view of wrench set 10 along line D-D of FIG. 3(a).

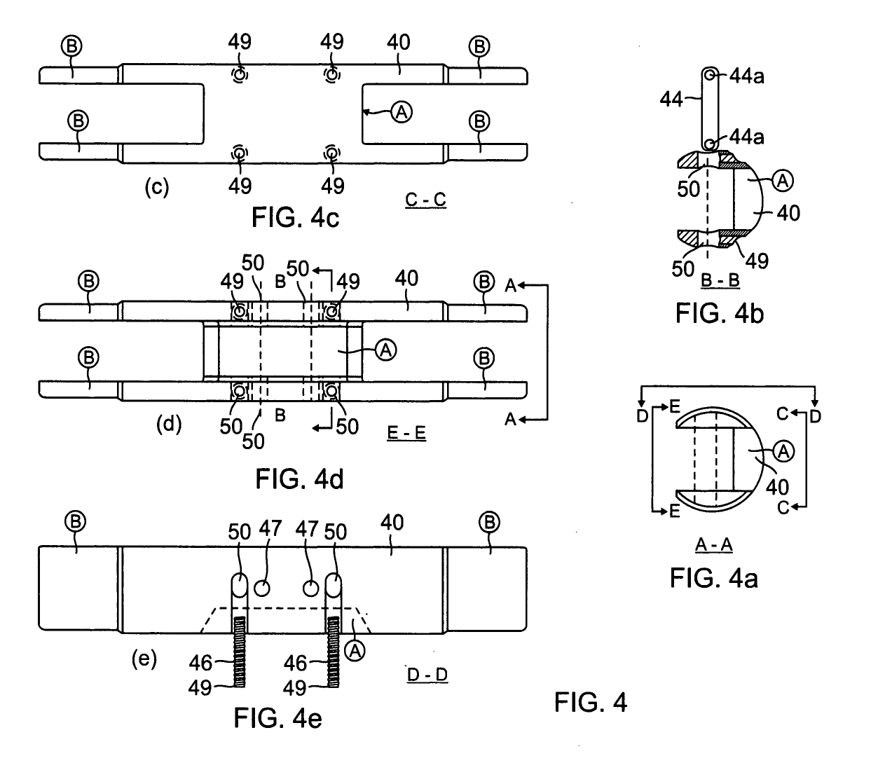

FIG. 4(a) is a view illustrating the position of pins 44 when a selected wrench 16 (½ inch socket) is in the extended and locked position as pins 44 fall into cross-slots 48 and 49 as a user forces thumb portion 30 in the forward (towards the right side of the sheet) direction.

FIG. 4(b) illustrates the position of pins 44 when wrench 16 is in the retracted (locked) position, pins 44 falling into the slots 49 and 50 as a user continues to force thumb portion 50 in the forward direction.

FIG. 4(c) illustrates pins 44 when wrench 16 is in the slideable (or transition) position, pins 44 riding on the surface 43 of horizontal slot 42 until either the retracted or extended and locked positions are selected as described with reference to FIGS. 4(a) and 4(b).

A user of wrench set 10 selects the desired socket size and then places his/her thumb on the knurled thumb portion 30 associated with the individual wrench having the selected socket size on one of its ends. The user then pushes the selected thumb portion in either the forward or reverse direction in order to have the selected socket size extend beyond the housing 40.

The movement of the selected wrench continues until the guide pins fall into the corresponding crosswise slot 48, the wrench effectively being locked in position. Note that the remaining three individual wrenches remain within housing 40 in the retracted position.

After the user completes his/her effort using the wrench, the user forces the associated thumb portion in the direction towards the middle of wrench set 10 until the guide pins 44 fall into cross-slots 48 as illustrated in FIG. 4(a). The pins 44 are retained within slots 48 by the combination of compression springs 46 and capscrews 49.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A multi-tiered wrench set comprising:
a housing having a longitudinal axis, and a slot extending along said horizontal axis;
a plurality of stacked wrenches having first and second ends positioned within said housing, said wrenches being slideable along said horizontal direction in either forward or reverse directions, each wrench having a longitudinal slot formed therein; and
means attached to said wrenches to allow a selected one of said wrenches to be moved in either said forward or reverse directions.

2. The wrench set of a claim 1 wherein each of said plurality of wrenches have sockets positioned at said first end.

3. The wrench set of claim 2 wherein said plurality of wrenches have sockets positioned at said second ends.

4. The wrench set of claim 3 further including at least one guide pin positioned within said slot.

5. The wrench set of claim 4 wherein said wrenches each contain a longitudinal slot, said guide pins being slideable along the surface of said longitudinal slot by said attachment means.

6. The wrench set of claim 5 further including stabilizer pins positioned within said housing to prevent the stacked wrenches from shifting laterally outwards.

7. The wrench set of claim 6 wherein said attached means comprises a knurled protrusion.

8. The wrench set of claim 5 wherein each of said wrench slots have a plurality of indentations along the length thereof.

9. The wrench set of claim 8 wherein said guide pin rests within a selected one of said plurality of indentations depending upon the position of a selected stacked wrench within said slot.
